(19) United States
(12) Patent Application Publication
(10) Pub. No.: US 2023/0416456 A1
(43) Pub. Date: Dec. 28, 2023

(54) RESIN COMPOSITION, COATING FILM USING SAME, AND ELECTROLYTE

(71) Applicant: MITSUBISHI GAS CHEMICAL COMPANY, INC., Tokyo (JP)

(72) Inventors: Noriyoshi OGAWA, Ibaraki (JP); Toshihito GOTO, Ibaraki (JP)

(73) Assignee: MITSUBISHI GAS CHEMICAL COMPANY, INC., Tokyo (JP)

(21) Appl. No.: 18/276,534

(22) PCT Filed: Feb. 18, 2022
(86) PCT No.: PCT/JP2022/006525

§ 371 Date: Aug. 9, 2023

(30) Foreign Application Priority Data
Feb. 25, 2021 (JP) 2021-028691

(51) Int. Cl. C08G 64/06; C09D 169/00; C09D 7/20; H01M 10/0565

(52) U.S. Cl. CPC C08G 64/06; C09D 169/00; C09D 7/20; H01M 10/0565

(57) ABSTRACT

According to the present invention, there can be provided a resin composition, comprising: a polycarbonate resin comprising a constituent unit represented by the following general formula (1):

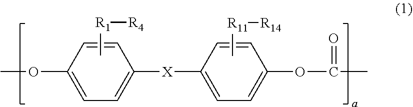

wherein R₁ to R₄ and R₁₁ to R₁₄ each independently hydrogen, fluorine, chlorine, bromine or iodine, etc., a represents an integer of 1 to 1,000, and X represents —S—, etc.; and a carbonate-based organic solvent, wherein the content of the polycarbonate resin in the resin composition is 0.05% to 50% by mass; the content of the carbonate-based organic solvent in the resin composition is 50% to 99.5% by mass, and the total percentage of constituent units represented by the following formulae (2) to (4) in all of the constituent units represented by the general formula (1) is 0% to 75% at a molar percentage:

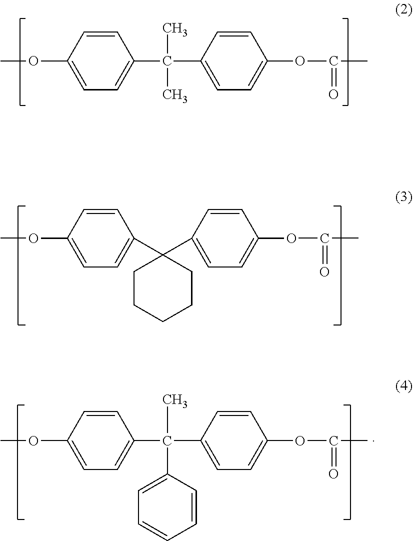

### TECHNICAL FIELD

The present invention relates to a resin composition that has low toxicity and can be easily applied as an ink or a painting material, and a coating film and an electrolyte using the same.

### BACKGROUND ART

The intended use of a specific polycarbonate resin, in which the polycarbonate resin is dissolved in an organic solvent and is used as an ink or a painting material, has been known, and various organic solvents have been used therefor. In recent years, a shift from halogen-based organic solvents, toluene, 1,4-dioxane and the like having safety concerns for humans, to safer solvents, has been promoted (Patent Literature 1).

On the other hand, carbonate-based solvents such as dimethyl carbonate and ethylene carbonate have relatively high safety, and thus, such carbonate-based solvents have been widely used as electrolyte solvents for lithium ion batteries. However, in order to use such a carbonate-based solvent as a polycarbonate electrolyte, there has been room for improvement, since the solubility of a polycarbonate resin in a carbonate-based solvent is low and a coating film is hardly obtained. In order to solve such a problem, various studies have been conducted, and for example, it has been proposed that methylene chloride is added as a solvent and the resin is coated as a colloidal solution (Patent Literature 2). However, since methylene chloride is a halogen-based solvent. causing a large environmental impact, there have been concerns about its safety for humans.

### CITATION LIST

### Patent Literature

### Patent Literature 1: WO2018/123282

### Patent Literature 2: JP Patent Publication (Kokai) No. 2000-357533 A

### SUMMARY OF INVENTION

### Technical Problem

It is an object of the present invention to provide a resin composition that has low toxicity and can be easily applied as an ink or a painting material, and a coating film and an electrolyte using the same.

The present inventors have focused on a carbonate-based organic solvent with low toxicity. However, a common bisphenol A-type polycarbonate resin cannot be dissolved in such a carbonate-based organic solvent. Thus, for dissolution of a polycarbonate resin, it has been necessary to improve the solubility of the polycarbonate resin itself in a solvent and then, to combine the polycarbonate resin with an optimal carbonate-based solvent.

### Solution to Problem

The present inventors have conducted intensive studies directed towards achieving the aforementioned object. As a result, the present inventors have found that a polycarbonate resin having a specific constituent unit has excellent solubility in a carbonate-based organic solvent with low toxicity, thereby completing the present invention.

Specifically, the present invention is as follows,
<1> A resin composition, comprising:
a polycarbonate resin comprising a constituent unit represented by the following general formula (1):

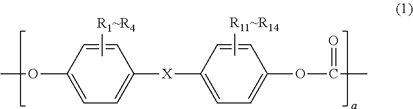

wherein
R₁ to R₄ and R₁₁ to R₁₄ each independently represent hydrogen, fluorine, chlorine, bromine or iodine, or an alkyl group containing 1 to 20 carbon atoms, an aryl group containing 6 to 12 carbon atoms, an alkenyl group containing 2 to 12 carbon atoms, an alkoxy group containing 1 to 5 carbon atoms, or an aralkyl group containing 7 to 17 carbon atoms, each of which optionally has a substituent,
a represents an integer of 1 to 1,000, and
X represents the following:

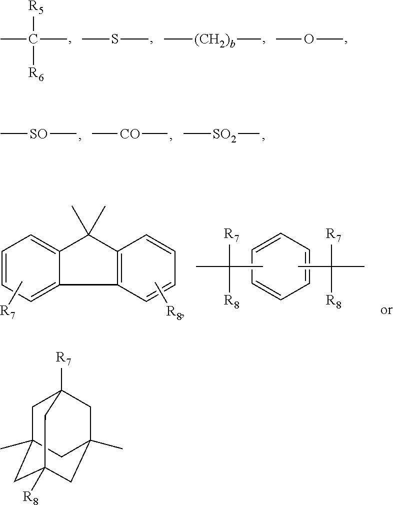

wherein, R₅ and R₆ each independently represent hydrogen, fluorine, chlorine, bromine or iodine, or an alkyl group containing 1 to 20 carbon atoms, an alkoxy group containing 1 to 5 carbon atoms, or an aryl group containing 6 to 12 carbon atoms, each of which optionally has a substituent, or R₅ and R₆ bind to each other to form a carbocyclic ring containing 5 to 20 carbon atoms, or a heterocyclic ring having 5 to 12 elements,
R₇ and R₈ each independently represent hydrogen, fluorine, chlorine, bromine or iodine, or an alkyl group containing 1 to 9 carbon atoms, an alkoxy group containing 1 to 5 carbon atoms, an alkenyl group containing 2 to 12 carbon atoms, or an aryl group containing 6 to 12 carbon atoms, each of which optionally has a substituent, and
b represents an integer of 0 to 20; and
a carbonate-based organic solvent, wherein
the content of the polycarbonate resin in the resin composition is 0.05% to 50% by mass,
the content of the carbonate-based organic solvent in the resin composition is 50% to 99.5% by mass, and
the total percentage of constituent units represented by the following formulae (2) to (4) in all of the constituent units represented by the general formula (1) is 0% to 75% at a molar percentage:

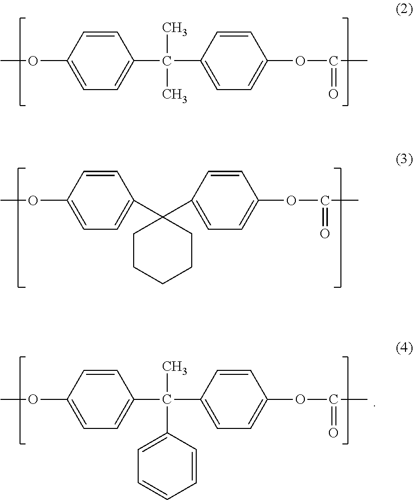

<2> The resin composition according to the above <1>, wherein the content of the carbonate-based organic solvent in the resin composition is 70% to 99% by mass.
<3> The resin composition according to the above <1> or <2>, wherein the carbonate-based organic solvent comprises at least one type selected from the group consisting of dimethyl carbonate, diethyl carbonate, and methyl ethyl carbonate;
<4> The resin composition according to the above <3>, wherein the carbonate-based organic solvent further comprises ethylene carbonate.
<5> The resin composition according to any one of the above <1> to <4>, wherein the constituent unit represented by the general formula (1) comprises one or more types selected from the group consisting of constituent units represented by the following formulae (5) to (9):

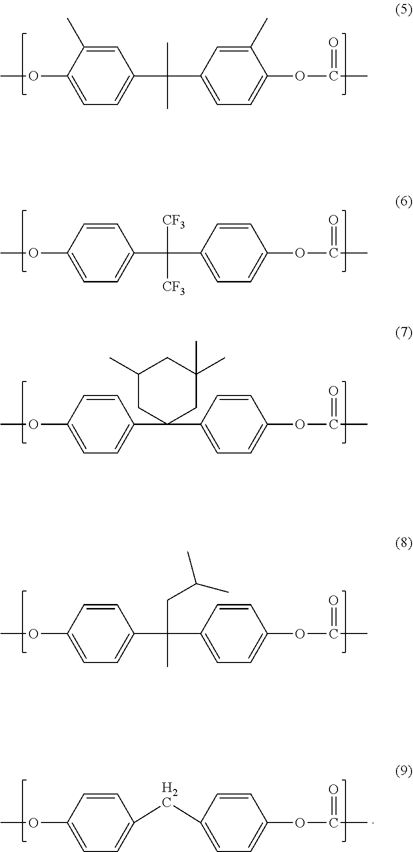

<6> The resin composition according to the above <5>, wherein the constituent unit represented by the general formula (1) comprises one or more types selected from the group consisting of the constituent units represented by the formulae (5), (6), and (8).
<7> The resin composition according to any one of the above <1> to <6>, wherein the polycarbonate resin has a limiting viscosity of 0.3 to 2.0 dl/g.
<8> The resin composition according to any one of the above <1> to <7>, which does not comprise organic solvents other than the carbonate-based organic solvent.
<9> A coating film prepared by drying the resin composition according to any one of the above <1> to <8>.
<10> An electrolyte prepared by dissolving 0.1% to 30% by mass of lithium salts in the resin composition according to any one of the above <1> to <8>.
<11> The electrolyte according to the above <10>, wherein the lithium salts comprise at least one of LiPF₆ and C₂F₆LiNO₄.
<12> A polymer gel electrolyte prepared by gelatinizing the electrolyte according to the above <10> or <11>.
<13> The polymer gel electrolyte according to the above <12>, wherein the electrical conductivity is 1 to 30,000 μS/cm.

### Advantageous Effects of Invention

The resin composition of the present invention has low toxicity compared with conventional polycarbonate resin solutions, and also, the present resin composition can be easily applied as an ink or a painting material, and the present resin composition is suitable for being coated onto, for example, various types of substrates to form a coating layer. Furthermore, the resin composition of the present invention is advantageous in that it is compatible with lithium salts, and exhibits conductivity even in a state in which a polycarbonate resin is dissolved, so that it functions as an electrolyte.

### DESCRIPTION OF EMBODIMENTS

Hereinafter, the present invention will be described in detail in the following embodiments and illustrative examples. However, these embodiments and illustrative examples are not intended to limit the scope of the present invention, and the present invention can be arbitrarily modified and carried out within a range in which it is not deviated from the spirit of the present invention.

### [Resin Composition]

The resin composition of the present invention is a resin composition, comprising:

a polycarbonate resin comprising a constituent unit represented by the following general formula (1):

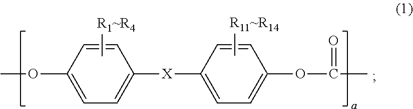

and

a carbonate-based organic solvent, wherein

the content of the polycarbonate resin in the resin composition is 0.05% to 50% by mass,

the content of the carbonate-based organic solvent in the resin composition is 50% to 99.5% by mass, and

the total percentage of constituent units represented by the following formulae (2) to (4) in all of the constituent units represented by the general formula (1) is 0% to 75% at a molar percentage:

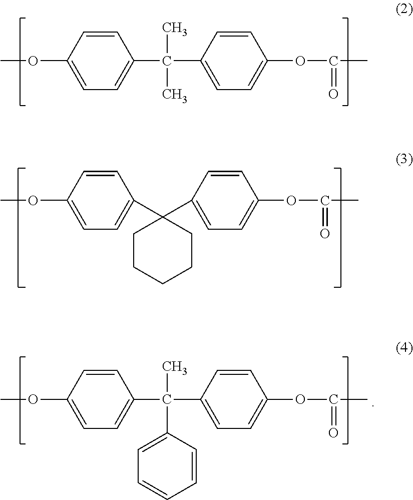

In the above general formula (1),
R₁ to R₄ and R₁₁ to R₁₄ each independently represent hydrogen, fluorine, chlorine, bromine or iodine, or an alkyl group containing 1 to 20 carbon atoms, an aryl group containing 6 to 12 carbon atoms, an alkenyl group containing 2 to 12 carbon atoms, an alkoxy group containing 1 to 5 carbon atoms, or an aralkyl group containing 7 to 17 carbon atoms, each of which optionally has a substituent.

It is to be noted that the “substituent” in the phrase “optionally have a substituent” may include “a fluorine atom, a chlorine atom, a bromine atom, an iodine atom, an alkyl group containing 1 to 7 carbon atoms, an aryl group containing 6 to 12 carbon atoms, an alkenyl group containing 2 to 7 carbon atoms, an alkoxy group containing 1 to 5 carbon atoms, an aralkyl group containing 7 to 17 carbon atoms” and the like (the same applies hereafter).

In the above general formula (1), a represents an integer of 1 to 1,000, preferably an integer of 10 to 900, and more preferably an integer of 30 to 600.

In the above general formula (1), X represents the following:

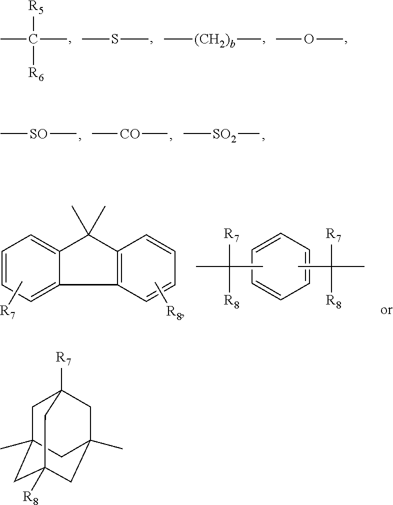

wherein, R₅ and R₆ each independently represent hydrogen, fluorine, chlorine, bromine or iodine, or an alkyl group containing 1 to 20 carbon atoms, an alkoxy group containing 1 to 5 carbon atoms, or an aryl group containing 6 to 12 carbon atoms, each of which optionally has a substituent, or R₅ and R₆ bind to each other to form a carbocyclic ring containing 5 to 20 carbon atoms, or a heterocyclic ring having 5 to 12 elements,

R₇ and R₈ each independently represent hydrogen, fluorine, chlorine, bromine or iodine, or an alkyl group containing 1 to 9 carbon atoms, an alkoxy group containing 1 to 5 carbon atoms, an alkenyl group containing 2 to 12 carbon atoms, or an aryl group containing 6 to 12 carbon atoms, each of which optionally has a substituent, and

b represents an integer of 0 to 20, preferably an integer of 1 to 15, and more preferably 1 to 10.

In the present invention, the constituent unit represented by the above general formula (1) preferably comprises one or more types selected from the group consisting of constituent units represented by the following formulae (5) to (9):

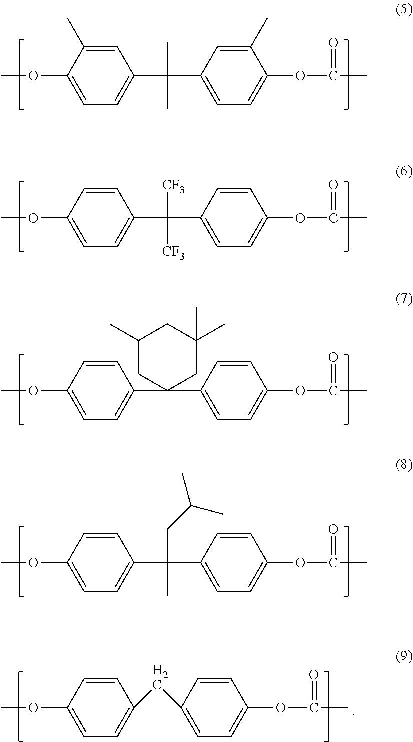

In particular, in the present invention, the constituent unit represented by the above general formula (1) preferably comprises one or more types selected from the group consisting of the constituent units represented by the above formulae (5), (6), and (8).

In the present invention, the total percentage of the constituent units represented by the above formulae (2) to (4) in all of the constituent units represented by the general formula (1) is, at a molar percentage, 0% to 75%, preferably 0% to 70%, and more preferably 0% to 60%. Since the lower limit value of the constituent units represented by the above formulae (2) to (4) is 0%, these constituent units are any given constituent units, which may not be comprised in the constituent unit represented by the general formula (1). Herein, the constituent unit represented by the above formula (2) is a constituent unit derived from 2,2-bis(4-hydrophenyl)propane (BPA), the constituent unit represented by the above formula (3) is a constituent unit derived from 1,1-bis(4-hydrophenyl)cyclohexane (BPZ), and the constituent unit represented by the above formula (4) is a constituent unit derived from 1,1-bis(4-hydrophenyl)-1-phenylethane (BPAP).

When the constituent unit represented by the general formula (1) only consist of the constituent units derived from 2,2-bis(4-hydrophenyl)propane (BPA), 1,1-bis(4-hydrophenyl)cyclohexane (BPZ), and 1,1-bis(4-hydrophenyl)-1-phenylethane (BPAP) (namely, 100% at a molar percentage), or when the percentage of such constituent units is high, namely, when such constituent units account for more than 75%, at a molar percentage, of the constituent unit represented by the general formula (1), the solubility of the polycarbonate resin in a carbonate-based organic solvent is decreased. The molar percentage of each constituent unit can be determined based on the molar percentage of monomers used upon the synthesis of the polycarbonate resin. Moreover, it is also possible to calculate the molar percentage according to an analysis such as nuclear magnetic resonance spectroscopy.

### <Polycarbonate Resin>

The polycarbonate resin used in the resin composition of the present invention can be produced by allowing bisphenols inducing the constituent unit represented by the general formula (1) to react with a carbonic acid ester-forming compound. Accordingly, the polycarbonate resin can be produced according to a known method that is used to produce a polycarbonate resin derived from bisphenol A, such as, for example, a direct reaction of bisphenols with phosgene (phosgene method) or a transesterification reaction of bisphenols with bisaryl carbonate (transesterification method).

A bisphenol serving as a raw material monomer for the polycarbonate resin used in the resin composition of the present invention is represented by the following general formula (11):

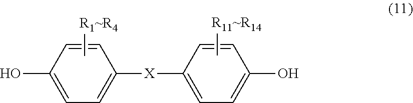

wherein R₁ to R₄, R₁₁ to R₁₄ and X are the same as those in the general formula (1).

Specific examples of the monomer represented by the above general formula (11) may include 4,4′-biphenyldiol, bis(4-hydrophenyl)methane, bis(2-hydrophenyl)methane, 2,4′-dihydroxydiphenylmethane, bis(4-hydrophenyl)ether, bis(4-hydrophenyl)sulfone, 2,4′-dihydroxydiphenylsulfone, bis(2-hydrophenyl)sulfone, bis(4-hydroxy-3-methylphenyl)sulfone, bis(4-hydrophenyl)sulfoxide, bis(4-hydrophenyl)sulfide, bis(4-hydrophenyl)ketone, 1,1-bis(4-hydrophenyl)ethane, 1,1-bis(4-hydrophenyl)-1-phenylethane, bis(4-hydrophenyl)diphenylmethane, 2,2-bis(4-hydrophenyl)propane, 2,2-bis(4-hydroxy-3-methylphenyl)propane, 1,1-bis(4-hydroxy-3-methylphenylethane, bis(4-hydroxy-3-methylphenyl)methane, 2,2-bis(4-hydroxy-3-t-butylphenyl)propane, 2,2-bis(4-hydrophenyl)butane, 2,2-bis(4-hydrophenyl)hexafluoropropane, 1,1-bis(4-hydrophenyl)cyclohexane, 1,1-bis(4-hydroxy-3-methylphenyl)cyclohexane, 1,1-bis(4-hydrophenyl)cycloundecane, 1,1-bis(4-hydrophenyl)cyclododecane, 2,2-bis(4-hydroxy-3-allylphenyl)propane, 3,3,5-trimethyl-1,1-bis(4-hydrophenyl)cyclohexane, 9,9-bis(4-hydroxy-3-ethylphenyl)fluorene, 9,9-bis(4-hydroxy-3-methylphenyl)fluorene, 9,9-bis(4-hydrophenyl)fluorene, 4,4-[1,4-phenylenebis(1-methylethylidene)]bisphenol, 4,4′-[1,3-phenylenebis(1-methylethylidene)]bisphenol, 2,2-bis(4-hydrophenyl)butane, 1,1-bis(4-hydrophenyl)-2-ethylhexane, 1,1-bis(4-hydrophenyl)-2-methylpropane, 2,2-bis(4-hydrophenyl)-4-methylpentane, 1,1-bis(4-hydrophenyl)decane, and 1,3-bis(4-hydrophenyl)-5,7-dimethyladamantane. These substances can be used in combination of two or more types.

Among these, in particular, bis(4-hydrophenyl)methane (BPF), 2,2-bis(4-hydrophenyl)propane (BPA), 2,2-bis(4-hydroxy-3-methylphenyl)propane (BPC), 1,1-bis(4-hydrophenyl)cyclohexane (BPZ), 1,1-bis(4-hydrophenyl)-1-phenylethane (BPAP), 3,3,5-trimethyl-1,1-bis(4-hydrophenyl)cyclohexane (TMC), 2,2-bis(4-hydrophenyl)-4-methylpentane (MIBK), and 2,2-bis(4-hydrophenyl)hexafluoropropane (BPAF) are preferable.

Besides, a single use of 2,2-bis(4-hydrophenyl)propane (BPA), 1,1-bis(4-hydrophenyl)cyclohexane (BPZ), or 1,1-bis(4-hydrophenyl)-1-phenylethane (BPAP) is not preferable because these monomers have low solubility in a common carbonate-based organic solvent such as dimethyl carbonate, diethyl carbonate, or methyl ethyl carbonate. Accordingly, when 2,2-bis(4-hydrophenyl)propane (BPA), 1,1-bis(4-hydrophenyl)cyclohexane (BPZ), or 1,1-bis(4-hydrophenyl)-1-phenylethane (BPAP) is used as a monomer represented by the above general formula (11), the amount of 2,2-bis(4-hydrophenyl)propane (BPA), 1,1-bis(4-hydrophenyl)cyclohexane (BPZ), or 1,1-bis(4-hydrophenyl)-1-phenylethane (BPAP) in the monomers represented by the above general formula (11) is, at a molar percentage, 0% to 75%, preferably 0% to 70%, and more preferably 0% to 60%.

Further, if the solubility in an electrolyte is emphasized, the monomer is more preferably selected from among 2,2-bis(4-hydrophenyl)propane (BPA), 1,1-bis(4-hydrophenyl)cyclohexane (BPZ), 2,2-bis(4-hydroxy-3-methylphenyl)propane, 2,2-bis(4-hydrophenyl)-4-methylpentane (MIBK), and 2,2-bis(4-hydrophenyl)hexafluoropropane (BPAF).

In the phosgene method, in general, the monomer represented by the above general formula (11) is allowed to react with phosgene in the presence of an acid binder and a solvent. As such an acid binder, for example, pyridine, or a hydroxide of an alkaline metal, such as sodium hydroxide or potassium hydroxide, is used. As such a solvent, for example, methylene chloride, chloroform, or the like is used. Furthermore, in order to promote a polycondensation reaction, a catalyst that is a tertiary amine such as triethylamine or a quaternary ammonium salt such as benzyltriethylammonium chloride is preferably added. Further, for the control of a polymerization degree, a monofunctional group compound such as phenol, p-t-butylphenol, p-cumylphenol, p-hydroxyphenethyl alcohol, 2-[2-hydroxy-5-[2-(methacryloyloxy)ethyl]phenyl]-2H-benzotriazole or long-chain alkyl-substituted phenol is preferably added as a molecular weight modifier. Further, as desired, an antioxidant such as sodium sulfite or hydrosulfite, or a branching agent such as phloroglucin or isatin bisphenol, may also be added in a small amount. The reaction is appropriately carried out in a temperature range of generally 0° C. to 150° C., and preferably 5° C. to 40° C. The reaction time depends on the reaction temperature, and it is generally 0.5 minutes to 10 hours, and preferably 1 minute to 2 hours. In addition, during the reaction, the pH in the reaction system is desirably retained at pH 10 or more.

On the other hand, in the transesterification method, the monomer represented by the above general formula (11) is mixed with bisaryl carbonate, and the mixture is reacted under reduced pressure at a high temperature. Examples of the bisaryl carbonate may include bisaryl carbonates such as diphenyl carbonate, di-p-tolyl carbonate, phenyl-p-tolyl carbonate, di-p-chlorophenyl carbonate, and dinaphthyl carbonate. These compounds can also be used in combination of two or more types. The reaction is carried out in a temperature range of generally 150° C. to 350° C., and preferably 200° C. to 300° C., and the pressure reduction degree is preferably set to be 1 mmHg or less at a final stage, so that phenols derived from the bisaryl carbonates generated by the transesterification reaction are distilled away from the reaction system. The reaction time depends on the reaction temperature, the pressure reduction degree, and the like, and the reaction time is generally about 1 to 24 hours. The reaction is preferably carried out in an inert gas atmosphere such as nitrogen or argon. Moreover, as desired, a molecular weight modifier, an antioxidant, and a branching agent may be added, and the reaction may be carried out.

The polycarbonate resin used in the resin composition of the present invention preferably has, with good balance, solvent solubility, coatability, peelability, scratch resistance, impact resistance, and the like, which are needed as a coating film-forming resin. By setting the lower limit value of the liming viscosity of the resin to be a predetermined value or more, the intensity of scratch resistance and impact resistance is improved. On the other hand, by setting the upper limit value of the limiting viscosity to be a predetermined value or less, a reduction in the solvent solubility and an increase in the solution viscosity are suppressed, and coatability is maintained. The limiting viscosity of the polycarbonate resin is preferably within the range of 0.3 to 2.0 dl/g, and more preferably within the range of 0.35 to 1.5 dl/g.

The amount of the polycarbonate resin mixed in the resin composition of the present invention is 0.05% to 50% by mass. In the case of the intended use of coating, the amount of the polycarbonate resin mixed is set to be preferably 1% to 30% by mass, and more preferably 1% to 20% by mass, depending on limiting viscosity and solvent solubility. When the amount of the polycarbonate resin mixed is within the above-described range, there is a better balance between solvent solubility and coatability, and workability and appearance are improved. On the other hand, when the resin composition of the present invention is used as an electrolyte, the amount of the polycarbonate resin mixed is preferably 0.1% to 10% by mass, and more preferably 0.5% to 5% by mass. There is a case where the polycarbonate resin is precipitated if the amount of the polycarbonate resin mixed exceeds 10% by mass, although it depends on the concentration of lithium salts.

### <Carbonate-Based Organic Solvent>

The resin composition of the present invention is a solution prepared by dissolving the above-described polycarbonate resin in a carbonate-based organic solvent, and when the present resin composition is in the form of such a solution, it is generally equivalent to a painting material called “clear color.” The resin composition of the present invention may also be a colored painting material composition prepared by dissolving or dispersing a desired dye and/or pigment in the present resin composition.

In the resin composition of the present invention, at least a carbonate-based organic solvent is used as a solvent. Specific examples of the carbonate-based organic solvent may include dimethyl carbonate (hereinafter abbreviated as “DMC”) that is a linear carbonate, diethyl carbonate (hereinafter abbreviated as “DEC”), methyl ethyl carbonate (hereinafter abbreviated as “MEC”), ethylene carbonate (hereinafter abbreviated as “EC”) that is a cyclic carbonate, propylene carbonate, vinylene carbonate, and fluoroethylene carbonate. In the present invention, two or more types of these substances can be used in combination. Among these substances, the present carbonate-based organic solvent preferably comprises any one of DMC, DEC and MEC, in which the polycarbonate resin is comparatively highly soluble. In addition, the carbonate-based organic solvent used in the present invention preferably comprises at least one selected from DMC, DEC and MEC, and further, ethylene carbonate. In this case, taking into consideration easy precipitation of the polycarbonate resin, the content of ethylene carbonate in the carbonate-based organic solvent is preferably less than 50% by mass.

In the present invention, the content of the carbonate-based organic solvent in the resin composition is 50% to 99.95% by mass. The content of the carbonate-based organic solvent in the resin composition is preferably 70% to 99% by mass, more preferably 75% to 99% by mass, and particularly preferably 80% to 99% by mass.

In the present invention, it is preferable to use a solvent that is constituted with only a combination of carbonate-based organic solvents. However, when the present resin composition is assumed to be used as a coating liquid, organic solvents that are not poisonous and deleterious substances as defined under the Japanese Poisonous and Deleterious Substances Control Law or specified chemical substances as defined under the Industrial Safety and Health Law may be added, in a range in which the added organic solvents do not impair the effects of the present invention. Specifically, the content of such an organic solvent other than the carbonate-based organic solvent in the resin composition of the present invention can be set to be approximately 0% to 30% by mass.

On the other hand, when the intended use of the resin composition of the present invention is assumed to be an electrolyte, in order to adjust solubility or viscosity, organic solvents with low impact on the electrolyte, such as acetonitrile, Tetraglyme and sulfolane, may be added, in a range in which the added organic solvents do not impair the effects of the present invention. Specifically, the content of such organic solvents other than the carbonate-based organic solvent in the resin composition of the present invention can be set to be approximately 0% to 30% by mass.

### <Optional Additives>

When the resin composition of the present invention is used for coating, in order to enhance color effects, pigments, dyes, coloring particles, and particles having optical coherence can be added. Examples of such pigments and dyes may include organic pigments such as an azo pigment and a phthalocyanine pigment. Specific examples thereof may include Red No. 104, Red No. 106, Red No. 201, Red No. 202, Red No. 204. Red No. 215, Red No. 220, Orange No. 203, Orange No. 204, Blue No. 1, Blue No. 404. Yellow No. 205, Yellow No. 401, and Yellow No. 405. Moreover, in order to exhibit white color, pearlescent color, metallic color and glittery feeling, it is also possible to use titanium mica, titanium oxide, iron oxide, tin oxide, zirconium oxide, chromium oxide, bismuth oxychloride, silica, chromium, titanium nitride, titanium, magnesium fluoride, gold, silver, nickel, etc. The particles having optical coherence are particles that enhance color effects as a result of light reflection or scattering, and examples of the particles having optical coherence may include glass beads, very small shells, and mica. These additives are preferably added within the range of 0.0001% to 10.0% by mass into the resin composition, as desired.

Further, as necessary, a corrosion inhibitor, an antioxidant, a dispersant, an ultraviolet ray absorber, an antifoaming agent, a leveling agent, etc. may also be added.

The viscosity of the resin composition of the present invention may be arbitrarily set depending on desired intended use. The viscosity of the present resin composition is preferably within the range of 1 to 20,000 mPa·s, and more preferably within the range of 5 to 10,000 mPa·s, Besides, when the resin composition of the present invention is used as an electrolyte, the viscosity thereof is preferably within the range of 1 to 10,000 mPa·s, and more preferably within the range of 10 to 5,000 mPa·s.

As a method of measuring the viscosity, for example, using the vibration type viscometer (CJV5000) manufactured by A & D Co., Ltd., the viscosity can be measured al a measurement temperature of 25° C.

The thickness of a coating film, which is obtained by applying the resin composition of the present invention and then drying it, is preferably within the range of 1 to 200 μm, more preferably within the range of 5 to 120 μm, and particularly preferably in range of 10 to 60 μm. By setting the thickness of the coating film to be 1 μm or more, the surface protection strength of the coating film can be ensured. On the other hand, by setting the thickness of the coating film to be 200 μm or less, the peeling of the coating film due to the shrinking thereof is favorably suppressed.

### [Electrolyte]

When the resin composition of the present invention is used as an electrolyte, it is preferable to add lithium salts in an amount of 0.1% to 30% by mass. Lithium salts are dissolved in the carbonate-based organic solvent, and specific examples of the lithium salts may include LiPF₆, C₂F₆LiNO₄, LiClO₄, LiBF₄, LiCoO₂, LiBOB, LiBH₄, Li(FSO₂)₂N, and Li(CF₃SO₂)₂N. Among these, the lithium salts preferably comprise at least one of LiPF₆ and C₂F₆LiNO₄. Moreover, a stabilizer for stabilizing the electrode surface, an overcharge inhibitor, a flame retardant or the like may be added in a small amount.

### [Polymer Gel Electrolyte]

The electrolyte of the present invention is concentrated and is partially gelatinized, so that a polymer gel electrolyte can be obtained. The method of concentrating the electrolyte is not particularly limited, and for example, a method of removing a part of the solvent by air drying, so as to obtain a highly viscous solution having a solidified surface, may be applied.

The electrical conductivity of the polymer gel electrolyte of the present invention at 20° C. is preferably 1 to 30,000 μS/cm, more preferably 10 to 20,000 μS/cm, and particularly preferably 100 to 10,000 μS/cm.

The polymer gel electrolyte of the present invention can be preferably used as a material for a lithium-ion polymer battery, an electric double layer capacitor, an electrolytic capacitor, and the like.

### EXAMPLES

Hereinafter, the examples of the present invention will be described together with comparative example, and the content of the present invention will be described in detail. However, these examples are not intended to limit the scope of the present invention.

### Example 1

102.4 g (0.4 mol) of 2,2-Bis(4-hydroxy-3-methylphenyl-)propane (hereinafter abbreviated as “BPC”; manufactured by Honshu Chemical Industry Co., Ltd.) and 0.1 g of hydrosulfite were dissolved in 1100 ml of 5 w/w % sodium hydroxide aqueous solution.

To this solution, 500 ml of methylene chloride was added, and while stirring, 0.5 g of benzyltriethylammonium chloride (hereinafter abbreviated as “TEBAC”) was added. Further, while the mixed solution was kept at 15° C., 60 g of phosgene was blown into the solution.

After completion of the blowing of phosgene into the solution, 1.5 g of p-t-butylphenol (hereinafter abbreviated as “PTBP”; manufactured by Dai Nippon Printing Co., Ltd.) was added as a molecular weight modifier to the solution, and was intensively stirred, so that the reaction solution was emulsified. After completion of the emulsification, 0.4 ml of triethylamine was added to the reaction mixture, and the thus obtained mixture was then stirred at 20° C. to 25° C. for about 1 hour for polymerization.

After completion of the polymerization, the reaction solution was separated into a water phase and an organic phase, and the organic phase was then neutralized with phosphoric acid. After that, water washing was repeatedly carried out until the electrical conductivity of the first solution (water phase) became 10 μS/cm or less. The obtained polymer solution was added dropwise into hot water retained at 45° C., and the solvent was then removed by evaporation to obtain a white powder precipitate. The obtained precipitate was filtrated, and was then dried at 105° C. for 24 hours, so as to obtain polymer powders.

The obtained polymer was analyzed by infrared absorption spectrometry. As a result, absorption due to carbonyl groups was found at a position around 1770 cm⁻¹, and absorption due to ether bonds was found at a position around 1240 cm⁻¹, and thus, the polymer was confirmed to be a polycarbonate resin having a carbonate bond (hereinafter abbreviated as “PC-1”).

The limiting viscosity of the obtained polycarbonate resin was measured according to the after-mentioned method. In addition, as described later, a resin composition comprising the obtained polycarbonate resin and each carbonate-based organic solvent was prepared, and individual resin compositions were subjected to a solvent solubility test and the measurement of a film thickness. Moreover, using the obtained polycarbonate resin, the after-mentioned Electrolyte A and Electrolyte B were prepared, and the electrical conductivity of each electrolyte was then measured. The results are shown in Table 1.

### <Limiting Viscosity (η) of Polycarbonate Resin>

The specific viscosity of a 0.5 g/dl polycarbonate resin in a methylene chloride solution was measured at a temperature of 25° C., using a Ubbelohde capillary viscometer, and thereafter, the limiting viscosity of the polycarbonate resin was calculated using a Huggins constant of 0.45 according to equation (1) as shown below,

The measurement conditions were as follows.
Measurement apparatus: Ubbelohde capillary viscometer
Solvent: Dichloromethane
Resin solution concentration: 0.5 g/dl (=C)
Measurement temperature: 25° C.
Specific viscosity: ηₛₚ

Using a Huggins constant of 0.45 (k′), the limiting viscosity [η] (dl/g) was obtained according to the following equation:

ηₛₚ/C=[η]+k′[η]²C (1).

### <Solvent Solubility Test>

The obtained polycarbonate resin was added into each carbonate-based organic solvent (dimethyl carbonate (DMC), diethyl carbonate (DEC), and methyl ethyl carbonate (MEC)), so that the concentration thereof became 1% by mass, 10% by mass, and 20% by mass, respectively, thereby preparing individual resin compositions. Each resin composition was placed in a glass sealed container, and it was then shaken with a shaker for 24 hours. Thereafter, the presence or absence of an undissolved matter was confirmed by visual observation. The determination criteria are as follows.
A: 20% By mass of the polycarbonate resin was completely dissolved.
B: 10% By mass of the polycarbonate resin was completely dissolved, but an undissolved matter was found in 20% by mass of the polycarbonate resin.
C: 1% By mass of the polycarbonate resin was completely dissolved, but an undissolved matter was found in 10% by mass of the polycarbonate resin.
D: 0.05% By mass of the polycarbonate resin was completely dissolved, but an undissolved matter was found in 1% by mass of the polycarbonate resin.
E: An undissolved matter was found in 0.05% by mass of the polycarbonate resin.

### <Coating Film Properties>

The obtained polycarbonate resin was added to dimethyl carbonate (DMC) to result in a concentration of 10% by mass, thereby preparing a resin composition. The prepared resin composition was subjected to a 200 μm gap coater (only in Example 7. a 400 μm gap coater was used) to obtain a coating film. The obtained coating film was air-dried for 1 day, and was then dried at 120° C. for 1 hour. The film thickness of the thus obtained coating film was measured.

### <Measurement of Electrical Conductivity>

Using commercially available C₂F₆LiNO₄ (manufactured by FUJIFILM Wako Pure Chemical Corporation), a dimethyl carbonate (DMC) solution containing 0.5 mol/L C₂F₆LiNO₄ was prepared, and the obtained solution was defined as Solution A. 5 Parts by mass of the polycarbonate resin and 85 parts by mass of DMC were placed in a hermetically sealed container, so that the polycarbonate resin was dissolved in DMC. While 10 parts by mass of the above-described Solution A was added to the obtained solution, the solution was stirred, so as to obtain Electrolyte A.

A 1.0 mol/L LiPF₆ solution containing commercially available LiPF₆ (volume ratio of EC:DEC=1:1) (LBG-96533 Electrolyte, manufactured by KISHIDA CHEMICAL CO., LTD. (1 mol/L LiPF₆; EC:DEC=1:1 v/v %) was defined as Solution B. Besides, “EC” indicates ethylene carbonate. 5 Parts by mass of the polycarbonate resin and 90 parts by mass of DMC were placed in a hermetically sealed container, so that the polycarbonate resin was dissolved in DMC. While 5 parts by mass of the above-described Solution B was added to the obtained solution, the solution was stirred, so as to obtain Electrolyte B. The electrical conductivity of the obtained Electrolytes A and B was measured.

The measurement apparatus: Electrical conductivity meter (waterproof electrical conductivity meter AS650, manufactured by AS ONE Corporation)

### Example 2

Polymerization was carried out in the same manner as that of Example 1, with the exceptions that the amount of BPC used was changed to 60.4 g and the amount of PTBP used was changed to 1.8 g, and that, at the same time, 40.1 g of 2,2-bis(4-hydrophenyl)propane (hereinafter abbreviated as “BPA”: manufactured by Mitsubishi Chemical Corporation) was used, so as to obtain a polycarbonate resin (hereinafter abbreviated as “PC-2”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1.

### Example 3

Polymerization was carried out in the same manner as that of Example 1, with the exceptions that, instead of BPC, 54 g of 2,2-bis(4-hydrophenyl)-4-methylpentane (hereinafter abbreviated as “MIBK”; manufactured by Honshu Chemical Industry Co., Ltd.) and 58 g of 1,1-bis(4-hydrophenyl)-1-phenylethane (hereinafter abbreviated as “BPAP”; manufactured by Honshu Chemical Industry Co., Ltd.) were used, that the amount of PTBP used was changed to 2.0 g, and that TEBAC was not used, so as to obtain a polycarbonate resin (hereinafter abbreviated as “PC-3”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1. It is to be noted that the measurement of the electrical conductivity of Electrolytes A and B was suspended because the polycarbonate resin was precipitated.

### Example 4

Polymerization was carried out in the same manner as that of Example 1, with the exceptions that 108 g of MIBK was used instead of BPC, that 4.3 g of 2-[2-hydroxy -5-[2-(methacryloyloxy)ethyl]phenyl]-2H-benzotriazole (hereinafter abbreviated as “BTAZ”; manufactured by Otsuka Chemical Co., Ltd.) was used instead of PTBP, and that TEBAC was not used, so as to obtain a polycarbonate resin (hereinafter abbreviated as “PC-4”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1.

### Example 5

Polymerization was carried out in the same manner as that of Example 1, with the exceptions that, instead of BPC, 36.0 g of bis(4-hydrophenyl)methane (hereinafter abbreviated as “BPF”; manufactured by Sanko Co., Ltd.) and 50.2 g of BPA were used, that the amount of PTBP used was changed to 0.93 g, and that TEBAC was not used, so as to obtain a polycarbonate resin (hereinafter abbreviated as “PC-5”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1. It is to be noted that the measurement of the electrical conductivity of Electrolytes A and B was suspended because the polycarbonate resin was precipitated.

### Example 6

Polymerization was carried out in the same manner as that of Example 1, with the exceptions that the amount of BPC used was changed to 60.4 g, and that, at the same time, 40.1 g of BPA and 1.92 g of p-hydroxyphenethyl alcohol (hereinafter abbreviated as “PHEP”; manufactured by Otsuka Chemical Co., Ltd.) were used, so as to obtain a polycarbonate resin (hereinafter abbreviated as “PC-6”).

The limiting viscosity of tie obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1.

### Example 7

Polymerization was carried out in the same manner as that of Example 1, with the exceptions that 124.0 g of 3,3,5-trimethyl-1,1-bis(4-hydrophenyl)cyclohexane (hereinafter abbreviated as “TMC”: manufactured by Sanko Co., Ltd.) was used instead. of BPC, that the amount of PTBP used was changed to 1.62 g, and that TEBAC was not used, so as to obtain a polycarbonate resin (hereinafter abbreviated as “PC-7”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1. It is to be noted that the measurement of the electrical conductivity of Electrolytes A and B was suspended because the polycarbonate resin was precipitated.

### Example 8

Polymerization was carried out in the same manner as that of Example 1, with the exceptions that, instead of BPC, 94.1 g of BPAF, 27.4 g of BPA and 1.10 g of PHEP were used, and that PTBP was not used, so as to obtain a polycarbonate resin (hereinafter abbreviated as “PC-8”).

The limiting viscosity of the obtained polycarbonate resin was measured in the same manner as that of Example 1. Furthermore, the obtained polycarbonate resin was used to prepare a resin composition and an electrolyte in the same manner as that of Example 1. Thereafter, a solvent solubility test and the measurement of film thickness and electrical conductivity were carried out. The results are shown in Table 1.

### Example 9

2.0 g of PC-1 obtained in Example 1 and 8.0 g of diethyl carbonate (DEC) were weighed, and were then placed in a 100 ml beaker, and PC-1 was dissolved in DEC by stirring the solution with a Teflon stirrer. After completion of the dissolution, while stirring, 1.0 ml of the aforementioned Solution B (LBG-96533 Electrolyte, manufactured by KISHIDA CHEMICAL CO., LTD. (1 mol/L LiPF₆; EC:DEC=1:1 v/v %)) was added dropwise into the reaction solution. When this Solution B was mixed with the reaction solution, the stirring was terminated, and the mass was measured (wherein the mass of the reaction solution excluding those of the beaker and the stirrer was 11.2 g before concentration). Thereafter, the beaker was left in a draft chamber for 24 hours, and a part of the solvent was removed by air drying, so as to obtain a highly viscous solution having a solidified surface. The mass of the solution was 8.1 g (after concentration). Thereafter, an electrical conductivity meter was inserted into this partially gelatinized (solvent-including) polymer gel electrolyte, and the electrical conductivity was then measured. The results are shown in Table 2.

Besides, the electrical conductivity was measured with the following apparatus.

The measurement apparatus: Electrical conductivity meter (waterproof electrical conductivity meter AS650, manufactured by AS ONE Corporation)

### Example 10

2.0 g of PC-8 obtained in Example 8 and 8.0 g of DEC were weighed, and were then placed in a 100 ml beaker, and PC-8 was dissolved in DEC by stirring the solution with a Teflon stirrer. After completion of the dissolution, while stirring, 2.5 ml of the aforementioned Solution B was added dropwise into the reaction solution. When this Solution B was mixed with the reaction solution, the stirring was terminated, and the mass was measured (wherein the mass of the reaction solution excluding those of the beaker and the stirrer was 13.0 g before concentration). Thereafter, the beaker was left in a draft chamber for 24 hours, and a part of the solvent was removed by air drying, so as to obtain a highly viscous solution having a solidified surface. The mass of the solution. was 7.1 g (after concentration). Thereafter, an electrical conductivity meter was inserted into this partially gelatinized (solvent-including) polymer gel electrolyte, and the electrical conductivity was then measured in the same manner as that of Example 9. The results are shown in Table 2.

### Comparative Example 1

Polymerization was carried out in the same manner as that of Example 1, with the exceptions that 91.2 g of BPA was used instead of BPC, that the amount of PTBP used was changed to 2.00 g, and that TEBAC was not used, so as to obtain a polycarbonate resin (hereinafter abbreviated as “PC-9”).

The limiting viscosity of the obtained polycarbonate resin was measured in the same manner as that of Example 1. In addition, the obtained polycarbonate resin was used to prepare a resin composition in the same manner as that of Example 1, and the prepared resin composition was subjected to a solvent solubility test. Moreover, using the resin composition prepared in the same manner as that of Example 1, a coating film was intended to be formed. However, a coating film could not be formed. Furthermore. Electrolytes A and B were prepared in the same manner as that of Example 1. The measurement of the electrical conductivity of Electrolytes A and B was suspended because the polycarbonate resin was precipitated. The results are shown in Table 1.

### Comparative Example 2

Polymerization was carried out in the same manner as that of Example 1, with the exceptions that 107.2 g of BPZ was used instead of BPC, that the amount of PTBP used was changed to 2.00 g, and that TEBAC was not used, so as to obtain a polycarbonate resin (hereinafter abbreviated as “PC-10”)

The limiting viscosity of the obtained polycarbonate resin was measured in the same manner as that of Example 1. In addition, the obtained polycarbonate resin was used to prepare a resin composition in the same manner as that of Example 1, and the prepared resin composition was subjected to a solvent solubility test. Moreover, using the resin composition prepared in the same manner as that of Example 1, a coating film was intended to be formed. However, a coating film could not be formed. Furthermore, Electrolytes A and B were prepared in the same manner as that of Example 1. The measurement of the electrical conductivity of Electrolytes A and B was suspended because the polycarbonate resin was precipitated. The results are shown in Table 1.

### Comparative Example 3

Polymerization was carried out in the same manner as that of Example 1, with the exceptions that 116.0 g of BPAP was used instead of BPC, that the amount of PTBP used was changed to 2.00 g, and that TEBAC was not used, so as to obtain a polycarbonate resin (hereinafter abbreviated as “PC-11”).

The limiting viscosity of the obtained polycarbonate resin was measured in the same manner as that of Example 1. In addition, the obtained polycarbonate resin was used to prepare a resin composition in the same manner as that of Example 1, and the prepared resin composition was subjected to a solvent solubility test. Moreover, using the resin composition prepared in the same manner as that of Example 1, a coating film was intended to be formed. However, a coating film could not be formed. Furthermore, Electrolytes A and B were prepared in the same manner as that of Example 1. The measurement of the electrical conductivity of Electrolytes A and B was suspended because the polycarbonate resin was precipitated. The results are shown in Table 1.

### Comparative Example 4

Polymerization was carried out in the same manner as that of Example 1, with the exceptions that, instead of BPC, 14.8 g of 4,4′-biphenyldiol (hereinafter abbreviated as “BP”; manufactured by Honshu Chemical Industry Co., Ltd.) and 73.0 g of BPA were used, that the amount of PTBP used was changed to 1.30 g, and that TEBAC was not used, so as to obtain a polycarbonate resin (hereinafter abbreviated as “PC-12”).

The limiting viscosity of the obtained polycarbonate resin was measured in the same manner as that of Example 1. In addition, the obtained polycarbonate resin was used to prepare a resin composition in the same manner as that of Example 1, and the prepared resin composition was subjected to a solvent solubility test. Moreover, using the resin composition prepared in the same manner as that of Example 1, a coating film was intended to be formed. However, a coating film could not be formed. Furthermore, Electrolytes A and B were prepared in the same manner as that of Example 1. The measurement of the electrical conductivity of Electrolytes A and B was suspended because the polycarbonate resin was precipitated. The results are shown in Table 1.

### Comparative Example 5

A composition was prepared in the same manner as that of Example 1, with the exceptions that the polycarbonate resin vas not used, and that the mass fraction of the polycarbonate resin was replaced with dimethyl carbonate (DMC). A coating film was intended to be formed using the obtained composition, but such a coating film could not be formed. Furthermore, Electrolytes A and B were prepared in the same manner as that of Example 1, with the exceptions that the polycarbonate resin was not used, and that the mass fraction of the polycarbonate resin was replaced with dimethyl carbonate (DMC). and the electrical conductivity thereof was then measured. The results are shown in Table 1.

TABLE 1

| | Polycarbonate resin | | | | | | | | | |
|---|---|---|---|---|---|---|---|---|---|---|
| | Polycarbonate | Raw material monomers | | | Solvent solubility test | | | | [symbol] | |
| | type | (molar ratio) | [symbol] | [symbol] | DMC | DEC | MEC | [symbol] | [symbol] A | [symbol] B |
| Example 1 | PC-1 | [symbol] (100) | PTBP | 0. [symbol] | A | A | A | 1 [symbol] | 1.6 | 19.8 |
| Example 2 | PC-2 | [symbol] C/BPA (57/43) | PTBP | 0. [symbol] | A | A | A | 1 [symbol] | 1.4 | 15.2 |
| Example 3 | PC-3 | [symbol] (50/50) | PTBP | 0. [symbol] | A | A | A | 1 [symbol] | [symbol] | [symbol] |
| Example 4 | PC-4 | M [symbol] BK (100) | [symbol] TAZ | 0. [symbol] | A | A | A | 1 [symbol] | 1.4 | 14.1 |
| Example 5 | PC-5 | [symbol] /BPA (45/55) | PTBP | 0. [symbol] 1 | A | A | A | 14 | [symbol] | [symbol] |
| Example 6 | PC-6 | BPC/BPA (57/43) | PHEP | 0.72 | A | A | A | 1 [symbol] | 1.4 | 26.0 |
| Example 7 | PC-7 | TMC (100) | PTBP | 0.4 [symbol] | A | A | A | 1 [symbol] | [symbol] | [symbol] |
| Example 8 | PC-8 | BPA [symbol] /BPA [symbol] (70/30) | PHEP | 0. [symbol] | A | A | A | 14 | 1.4 | 17.2 |
| Comp. Ex. 1 | PC-9 | BPA (100) | PTBP | 0.49 | [symbol] | [symbol] | [symbol] | Not [symbol] | [symbol] | [symbol] |
| Comp. Ex. 2 | PC-10 | BPZ (100) | PTBP | 0.44 | [symbol] | [symbol] | [symbol] | Not [symbol] | [symbol] | [symbol] |
| Comp. Ex. 3 | PC-11 | BPA [symbol] (100) | PTBP | 0.43 | [symbol] | [symbol] | [symbol] | Not [symbol] | [symbol] | [symbol] |
| Comp. Ex. 4 | PC-12 | B [symbol] /BPA [symbol] (20/80) | PTBP | 0.76 | [symbol] | [symbol] | [symbol] | Not [symbol] | [symbol] | [symbol] |

| | | | | |
|---|---|---|---|---|
| Comp. Ex. 5 | [symbol] | [symbol] | [symbol] | [symbol] |

[symbol]

indicates data missing or illegible when filed

TABLE 2
Composition at time point in which Solution B was mixed and stiring was terminated (before concentration)

| | | Polycarbonate | Li salt | Carbonate |
|---|---|---|---|---|
| | Polycarbonate | component (% | component (% | solvent (% by |
| | type | by mass) | by mass) | mass) |
| Example 9 | PC-1 | 17.9 | 1.4 | 80.7 |
| Example 10 | PC-8 | 15.4 | 2.9 | 81.7 |

Composition and electrical conductivity of highly viscous solution with
solidified surface after removed of part of solvent (after concentration)

| | | Polycarbonate | Li salt | Carbonate | Electrical |
|---|---|---|---|---|---|
| | Polycarbonate | component (% | component (% | solvent (% by | conductivity |
| | type | by mass) | by mass) | mass) | μS/cm |
| Example 9 | PC-1 | 24.7 | 1.9 | 73.4 | 20 |
| Example 10 | PC-8 | 28.2 | 5.4 | 56.4 | 108 |

BPC 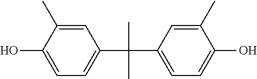 [SMILES: Cc1cc(C(C)(C)c2ccc(O)c(C)c2)ccc1O]
TMC 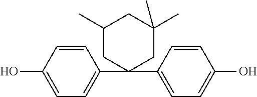 [SMILES: CC1CC(C)(C)CC(c2ccc(O)cc2)(c2ccc(O)cc2)C1]
PTBP 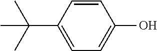
MIBK 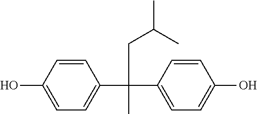 [SMILES: CC(C)CC(C)(c1ccc(O)cc1)c1ccc(O)cc1]
BPZ 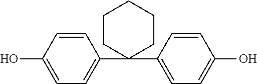 [SMILES: Oc1ccc(C2(c3ccc(O)cc3)CCCCC2)cc1]
STAZ 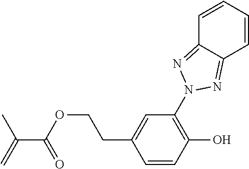 [SMILES: C=C(C)C(=O)OCCc1ccc(O)c(-n2nc3ccccc3n2)c1]
BPAP 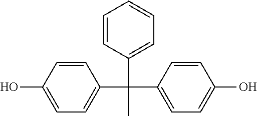 [SMILES: CC(c1ccccc1)(c1ccc(O)cc1)c1ccc(O)cc1]
BPAF 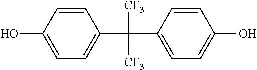 [SMILES: Oc1ccc(C(c2ccc(O)cc2)(C(F)(F)F)C(F)(F)F)cc1]
PHEP 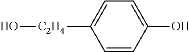
BPA 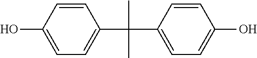 [SMILES: CC(C)(c1ccc(O)cc1)c1ccc(O)cc1]
BP 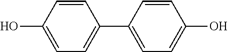 [SMILES: Oc1ccc(-c2ccc(O)cc2)cc1]
BPF

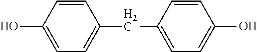 [SMILES: Oc1ccc(Cc2ccc(O)cc2)cc1]

### INDUSTRIAL APPLICABILITY

The resin composition of the present invention is a resin composition prepared by dissolving a highly soluble polycarbonate resin in a carbonate-based organic solvent, and this resin composition has low toxicity and is preferable as a coating material (a painting material or an ink) onto various types of substrates. Moreover, the present resin composition is compatible with lithium salts, and thus, even though the polycarbonate resin is dissolved, the resin composition maintains high conductivity and is useful as an electrolyte. In particular, the resin composition of the present invention is useful for modification of an SEI (Solid Electrolyte Interphase) layer of the electrolyte of a lithium-ion battery or a lithium-ion polymer battery, and is able to impart flame retardance and the like to a lithium-ion battery or a lithium-ion polymer battery. Furthermore, a concentrated solution of the electrolyte of the present invention can be gelatinized, and can be applied as a polymer gel electrolyte of a lithium-ion polymer battery.

1. A resin composition, comprising:
a polycarbonate resin comprising a constituent unit represented by the following general formula (1): 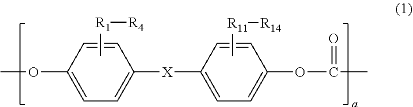
wherein
R₁ to R₄ and R₁₁ to R₁₄ each independently represent hydrogen, fluorine, chlorine, bromine or iodine, or an alkyl group containing 1 to 20 carbon atoms, an aryl group containing 6 to 12 carbon atoms, an alkenyl group containing 2 to 12 carbon atoms, an alkoxy group containing 1 to 5 carbon atoms, or an aralkyl group containing 7 to 17 carbon atoms, each of which optionally has a substituent,
a represents an integer of 1 to 1,000, and
X represents the following: 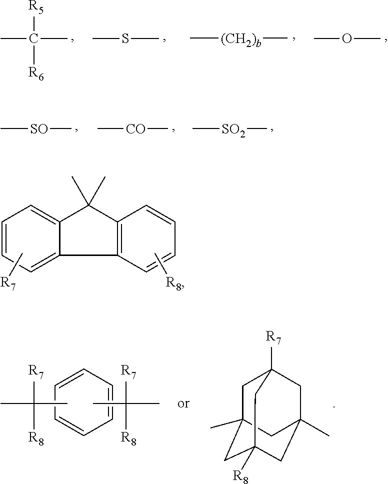
wherein, R₅ and R₆ each independently represent hydrogen, fluorine, chlorine, bromine or iodine, or an alkyl group containing 1 to 20 carbon atoms, an alkoxy group containing 1 to 5 carbon atoms, or an aryl group containing 6 to 12 carbon atoms, each of which optionally has a substituent, or R₅ and R₆ bind to each other to form a carbocyclic ring containing 5 to 20 carbon atoms, or a heterocyclic ring having 5 to 12 elements,
R₇ and R₈ each independently represent hydrogen, fluorine, chlorine, bromine or iodine, or an alkyl group containing 1 to 9 carbon atoms, an alkoxy group containing 1 to 5 carbon atoms, an alkenyl group containing 2 to 12 carbon atoms, or an aryl group containing 6 to 12 carbon atoms, each of which optionally has a substituent, and
b represents an integer of 0 to 20; and
a carbonate-based organic solvent, wherein
a content of the polycarbonate resin in the resin composition is 0.05% to 50% by mass,
a content of the carbonate-based organic solvent in the resin composition is 50% to 99.5% by mass, and
a total percentage of constituent units represented by the following formulae (2) to (4) in all of the constituent units represented by the general formula (1) is 0% to 75% at a molar percentage:

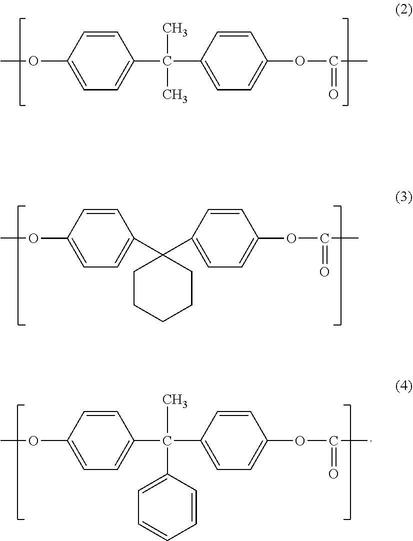

2. The resin composition according to claim 1, wherein the content of the carbonate-based organic solvent in the resin composition is 70% to 99% by mass.

3. The resin composition according to claim 1, wherein the carbonate-based organic solvent comprises at least one type selected from the group consisting of dimethyl carbonate, diethyl carbonate, and methyl ethyl carbonate.

4. The resin composition according to claim 3, wherein the carbonate-based organic solvent further comprises ethylene carbonate.

5. The resin composition according to claim 1, wherein the constituent unit represented by the general formula (1) comprises one or more types selected from the group consisting of constituent units represented by the following formulae (5) to (9):

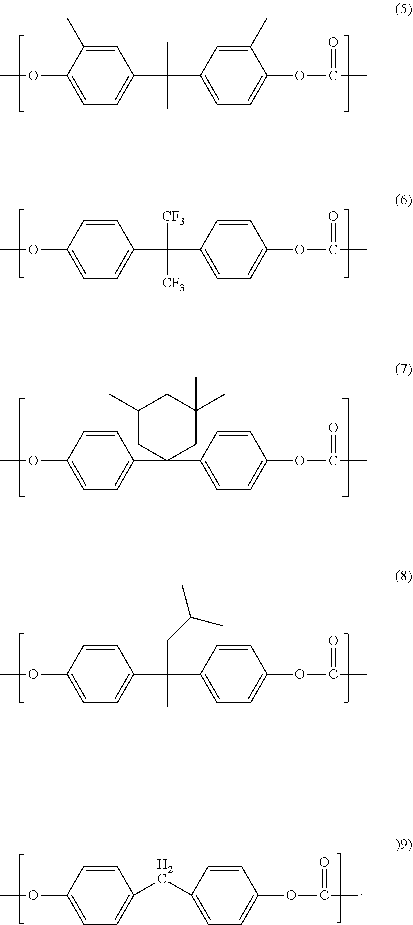

6. The resin composition according to claim 5, wherein the constituent unit represented by the general formula (1) comprises one or more types selected from the group consisting of the constituent units represented by the formulae (5), (6), and (8).

7. The resin composition according to claim 1, wherein the polycarbonate resin has a limiting viscosity of 0.3 to 2.0 dl/g.

8. The resin composition according to claim 1, which does not comprise organic solvents other than the carbonate-based organic solvent.

9. A coating film formed by drying the resin composition according to claim 1.

10. An electrolyte, in which 0.1% to 30% by mass of lithium salts are dissolved in the resin composition according to claim 1.

11. The electrolyte according to claim 10, wherein the lithium salts comprise at least one of LiPF₆ and C₂F₆LiNO₄.

12. A polymer gel electrolyte prepared by gelatinizing the electrolyte according to claim 10.

13. The polymer gel electrolyte according to claim 12, wherein an electrical conductivity is 1 to 30,000 μS/cm.
